(19) United States
(12) Patent Application Publication
(10) Pub. No.: US 2026/0202221 A1
(43) Pub. Date: Jul. 16, 2026

(54) MATERIAL REMOVAL DEVICE COMPRISING AN IMPEDANCE DETECTION SYSTEM FOR DETECTING THE TOOL COMING INTO CONTACT WITH A METAL REINFORCEMENT CONTAINED IN THE OBJECT BEING WORKED ON

(71) Applicant: COMPAGNIE GENERALE DES ETABLISSEMENTS MICHELIN, Clermont-Ferrand (FR)

(72) Inventors: Frédéric RAMZ, Clermont-Ferrand (FR); Aurélien MONTOY, JR., Clermont-Ferrand (FR); Matthieu LUTZ, Clermont-Ferrand (FR); Matthieu ROJDA, Clermont-Ferrand (FR)

(21) Appl. No.: 19/135,063

(22) PCT Filed: Dec. 6, 2023
(86) PCT No.: PCT/EP2023/084544

§ 371 Date: Jun. 2, 2025

(30) Foreign Application Priority Data
Dec. 9, 2022 (FR) 2213096

(51) Int. Cl. G01D 5/241

(52) U.S. Cl. CPC G01D 5/2417

(57) ABSTRACT

At least part of an electrically insulating coating that covers at least one insert is removed from the object by way of the tool. A first electrode is placed opposite the object so as to form, with the insert, a first capacitor, a first plate of which is formed by the first electrode and a second plate of which is formed by the insert. A second electrode is associated with the tool such that, when the tool comes into contact with the insert, an electrical connection is established between the second electrode and the insert that forms the second plate of the first capacitor. A variation in impedance caused by the electrical connection of the first capacitor to the second electrode is detected.

### CROSS-REFERENCE TO RELATED APPLICATIONS

This application claims priority to and the benefit of PCT Patent Application No. PCT/EP2023/084544, filed on Dec. 6, 2023, and entitled “MATERIAL REMOVAL DEVICE COMPRISING AN IMPEDANCE DETECTION SYSTEM FOR DETECTING THE TOOL COMING INTO CONTACT WITH A METAL REINFORCEMENT CONTAINED IN THE OBJECT BEING WORKED ON,” and to French Patent App. No. FR 2,213,096, filed on Dec. 9, 2022, and entitled “MATERIAL REMOVAL DEVICE COMPRISING AN IMPEDANCE DETECTION SYSTEM FOR DETECTING THE TOOL COMING INTO CONTACT WITH A METAL REINFORCEMENT CONTAINED IN THE OBJECT BEING WORKED ON,” the entire contents of which are both herein incorporated by reference.

### BACKGROUND

### 1. Field

The present disclosure relates to the general field of material removal devices and methods intended to remove an electrically insulating material that covers an electrically conductive insert without damaging the insert.

The present disclosure is more particularly applicable in the field of the processing of tires, in particular pneumatic tires, which comprise at least one rubber layer, thereby forming an electrically insulating coating, and at least one reinforcing ply comprising metal reinforcing cables, thereby forming electrically conductive inserts, from which tires it is desired to remove at least part of the rubber layer, for example for the purpose of repairing the carcass of the tire in question with a view to retreading the tire.

During the process of retreading pneumatic tires, in particular pneumatic tires intended for heavy goods vehicles, it is known practice to inspect the carcass to be retreaded in order to detect any damage thereto, such as holes, rubber tearing, cuts or traces of corrosion of the reinforcing cables and, where possible, to repair this damage before installing a new tread on the carcass. Conversely, if repair is impossible, the carcass is scrapped.

By way of example, it is known practice, when the carcass has a cut in its surface rubber layer, to hollow out the rubber layer over the entire extent of the cut until reaching the underlying reinforcing cables in order to check that the reinforcing cables have not also been damaged. If the reinforcing cables are intact, the recess is then filled in by way of a rubber-based repair coating.

Until now, damage has been detected visually, while the tasks of hollowing out the rubber and then repairing are carried out manually. In particular, the hollowing-out operation is generally performed through abrasion, by way of a brush with metal bristles carried by the operator. These various operations of inspecting and then repairing carcasses therefore require the presence of a well-trained and particularly skilled operator.

It is also known practice, in order to expose the carcass of the tire with a view to retreading the carcass, to remove the rubber layer corresponding to the worn tread by way of a machine comprising, on the one hand, a rotating drum to which the worn tire is fixed and then driven in rotation and, on the other hand, a material removal tool, such as a rasp, which bears against the tire in order to gradually remove the rubber.

In order not to damage the reinforcing cables during this rubber removal operation, document U.S. Pat. No. 9,669,594 has proposed to implement an inductive detection system that comprises, on the one hand, an induction coil that makes it possible to generate a magnetic field that brings about the occurrence of an induced voltage in the reinforcing cables and, on the other hand, a voltage sensor that detects a rise in the potential of the tool when the tool comes into contact with the reinforcing cables thus subjected to a voltage.

One drawback of such a device is that it is necessary to electrically insulate the tool and its tool holder, and more particularly to separate them from the electrical ground of the rest of the machine, so that the tool is able to adopt the potential of the reinforcing cables when it comes into contact therewith. This complicates the design of the machine, and may potentially present a risk of electric shock for the operator who has to work on the machine. Indeed, there is a risk that the tool or the casing protecting the tool, which is not grounded, will accidentally be subjected to a voltage, for example in the event that the motor driving the tool were to experience an electrical fault.

### SUMMARY

The objectives assigned to the present disclosure are therefore aimed at overcoming the abovementioned drawbacks and proposing a material removal device intended to work on an object comprising an electrically insulating coating that covers at least one electrically conductive insert, and more particularly a device for removing rubber from tires that, while having a simple, compact and safe structure, allows automatic, reliable and reproducible removal of material without a risk for the operators working on the device and that preserves the structural integrity of the one or more inserts contained in the object from which the material is removed.

The objectives assigned to the present disclosure are achieved by way of a material removal device intended to work on an object, such as a pneumatic tire, comprising an electrically insulating coating that covers at least one electrically conductive insert, the device comprising at least one material removal tool that is arranged so as to be able to remove some of the electrically insulating coating from the object, the device being characterized in that it comprises a detection system for detecting, through an impedance measurement, the material removal tool coming into contact with the electrically conductive insert, the detection system comprising:
a first electrode that is arranged so as to be placed opposite the object, at a distance from the electrically conductive insert, so as to form, with the electrically conductive insert, a dipole, referred to as “first dipole”, a first terminal of which is formed by the first electrode and a second terminal of which is formed by the electrically conductive insert,
a second electrode that is associated with the material removal tool such that, when the material removal tool comes into contact with the electrically conductive insert, an electrical connection is established between the second electrode and the electrically conductive insert forming the second terminal of the first dipole, —a control unit that is arranged so as to measure an impedance of a detection circuit containing the first dipole and to detect a variation in the impedance of the detection circuit caused by the electrical connection of the first dipole to the second electrode brought about by the material removal tool coming into contact with the electrically conductive insert.

Advantageously, the detection system according to the present disclosure utilizes the very structure of the object being worked on by considering that all or part of the structure of the object may be assimilated to an electric dipole that will thereby inherently possess impedance properties, in particular capacitive impedance properties, which will vary, during a material removal operation, due to the structural change induced by the material removal operation, in a manner that will be able to be detected by a suitable detection circuit.

The impedance measurement-based detection system according to the present disclosure is therefore particularly simple and compact to implement and also highly versatile since it is able to adapt easily to objects of various dimensions and structures, for example to tires having a variety of sizes and/or architectures, with a few simple adjustments of the control unit, such as a simple redefinition of impedance variation thresholds considered to be representative of the material removal tool coming into contact with an electrically conductive insert.

Furthermore, because it is possible to evaluate an impedance and variations thereof by measuring relatively low currents generated by a particularly low excitation voltage, and also while keeping a connection of the material removal tool at the ground of the device, the detection system according to the present disclosure presents absolutely no electrical risk either to the machine or to the operator.

Moreover, the present disclosure may, more specifically, as will be seen later, take advantage of the structure of an object that alternates between conductive material and insulating material to create a first capacitor-type dipole, which maintains insulation between its first plate and its second plate, and therefore between the first electrode and the second electrode, including when the tool and therefore the second electrode touches the conductive insert. This in particular allows the second electrode to be connected to the ground of the device, thereby simplifying the structure of the detection system and improving the safety of the device.

The detection system according to the present disclosure also exhibits excellent sensitivity and a very short response time, in particular when it is based on a capacitive impedance measurement, thereby making it possible to detect the occurrence of contact between the material removal tool and the conductive material insert almost instantaneously, and therefore to stop the hollowing-out operation automatically and almost instantaneously as soon as the material removal tool reaches the insert, and therefore without the material removal tool having time to damage the insert.

### BRIEF DESCRIPTION OF THE DRAWINGS

Other objectives, features and advantages of the present disclosure will become apparent in more detail on reading the following description and with the aid of the appended drawings, which are provided purely by way of non-limiting illustration, and in which:

FIG. 1 illustrates, in an overall front view, one example of a device according to the present disclosure, intended to remove rubber from pneumatic tires, and that for this purpose comprises a support arranged so as to hold the tire by its beads, the support here having four jaws, at least one of which contains a first electrode.

FIG. 2 is a detailed view of the device of FIG. 1, in longitudinal section, in a radial cutting plane containing the central axis of the tire and passing through one of the jaws of the support.

FIG. 3 is an enlarged partial view of FIG. 2, showing the layered structure of the support, here the layered structure of the jaw, which layered structure makes it possible to create, on the one hand, a first capacitor with the tire, in a first branch of the detection circuit corresponding to the first dipole, and, on the other hand, a second capacitor forming a second branch of the detection circuit, parallel to the first branch.

FIG. 4 shows an equivalent circuit diagram of a device implemented according to the present disclosure, when the material removal tool is located at a distance from the electrically conductive insert, and the first branch containing the second terminal of the first dipole, here the second plate of the first capacitor, on the one hand, and the second electrode associated with the material removal tool, on the other hand, forms an open circuit.

FIG. 5 is a view of the equivalent circuit diagram of FIG. 4 when the material removal tool comes into contact with the electrically conductive insert and thus closes the circuit of the first branch by connecting the second terminal of the first dipole, here the second plate of the first capacitor, to the second electrode associated with the material removal tool.

### DETAILED DESCRIPTION OF THE ENABLING EMBODIMENT

The present disclosure relates to a material removal device 1 intended to work on an object 2 that comprises an electrically insulating coating 3, such as a rubber-based coating 3, which covers at least one electrically conductive insert 4, such as a metal reinforcing cable.

The object 2 may, according to one preferred application of the present disclosure, be a tire 30 intended to be fitted on a wheel or a track of a vehicle, for example a pneumatic tire 30.

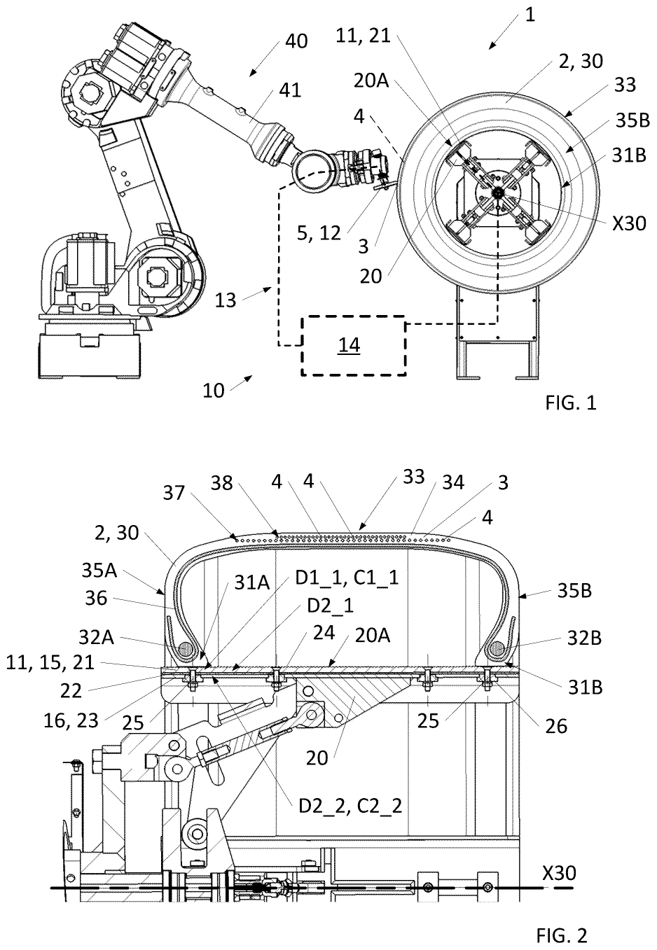

In a manner known per se, and as may be seen in FIGS. 1 and 2, such a pneumatic tire 30 may comprise a first bead 31A and a second bead 31B that are intended to allow the tire 30 to be fixed to a rim and that contain, for this purpose, annular reinforcing structures known as “bead wires” 32A, 32B, a crown 33 provided with a tread 34, and also a first sidewall 35A and a second sidewall 35B that connect the crown 33 to the first bead 31A and to the second bead 31B, respectively.

Such a tire 30 is reinforced by a reinforcement, or “carcass”, which generally comprises a plurality of reinforcing plies 36, 37, 38 each having a plurality of reinforcing cables that are embedded in a layer of rubber-based material. More particularly, the tire 30 generally comprises at least one carcass ply 36 that joins the first bead wire 32A to the second bead wire 32B by passing successively through the first sidewall 35A, the crown 33 and then the second sidewall 35B, and also crown plies 37, 38, the reinforcing cables of which intersect with those of the carcass ply 36.

If the object 2 under consideration is a tire 30, the insulating coating 3 within the meaning of the present disclosure may correspond to one or more rubber-based layers that cover the crown 33 and/or the sidewalls 35A, 35B and/or the reinforcing cables of the plies 36, 37, 38 of the tire 30. It should be noted in this respect that one particularly preferred application of the present disclosure relates to the removal of material forming the tread 34 that covers the crown 33 of the tire 30.

The electrically conductive inserts 4 may for their part correspond to the metal reinforcing cables that are present in one or more of the reinforcing plies 36, 37, 38, in particular in the carcass ply 36.

By way of preferred convention, the term “conductive” may be used to qualify a material the resistivity of which is less than 10⁻⁴ Ohm·m at a temperature of 300 K. Similarly, the term “insulating” may preferably be used to qualify a material the resistivity of which is greater than 10⁶ Ohm·m at a temperature of 300 K. Of course, more generally, the resistivity of the material the to be “insulating” within the meaning of the present disclosure will always be, relative to the resistivity of the material the to be “conductive”, strictly greater than the resistivity of the material the to be “conductive”, for example at least 10³ times (one thousand times) greater, at least 10⁵ times (one hundred thousand times) greater, preferably at least 10⁶ times (one million times) greater, or even at least 10⁸ times (one hundred million times) greater, than the resistivity of the material the to be “conductive”.

As may be seen in FIG. 1, the device 1 comprises at least one material removal tool 5 that is arranged so as to be able to remove some of the electrically insulating coating 3 from the object 2.

The material removal tool 5 is designed to be able to tear off some of the coating 3 by cutting or abrasion.

The material removal tool 5 may for example be formed by a brush, more particularly and preferably a brush with metal bristles, even more preferably a rotary brush with metal bristles. As a variant, the material removal tool 5 may be formed by a knife, a rasp, a carding machine, a milling cutter or a grinding wheel.

According to the present disclosure, the device 1 comprises a detection system 10 that makes it possible to detect, through an impedance measurement, the material removal tool 5 coming into contact with the electrically conductive insert 4.

The detection system 10 comprises firstly, as may be seen in FIGS. 1, 2, 3, 4 and 5, a first electrode 11 that is arranged so as to be placed opposite the object 2, at a distance from the electrically conductive insert 4, so as to form, with the electrically conductive insert 4, a dipole D1, referred to as “first dipole” D1, a first terminal D1_1 of which is formed by the first electrode 11 and a second terminal D1_2 of which is formed by the electrically conductive insert 4.

More preferably, the detection system 10 is a capacitive detection system 10 within which the first electrode 11 is arranged so as to be placed opposite the object 2, at a distance from the electrically conductive insert 4, so as to form, with the electrically conductive insert 4, a capacitor C1, referred to as “first capacitor” C1, a first plate C1_1 of which is formed by the first electrode 11, which corresponds here to the first terminal D1_1 of the first dipole D1, and a second plate C1_2 of which is formed by the electrically conductive insert 4, which corresponds here to the second terminal D1_2 of the first dipole D1.

Preferably, the first electrode 11 will be arranged so as to be able to come into mechanical contact with the object 2, and more preferably into contact with a zone of the object 2 that is covered by an external layer of electrically insulating material, which external layer may in this respect be considered, in absolute terms, as a portion of the electrically insulating coating 3 within the meaning of the present disclosure, even if this external layer preferably forms a portion of the coating 3 that is not intended to be removed from the object 2 by the material removal tool 5, and that is only adjacent to another zone of the coating 3 that, for its part, is intended to be removed by the tool 5. In any event, the presence of such an external layer of electrically insulating material belonging to the object 2 makes it possible to electrically separate the first electrode 11 from the rest of the structure of the object 2, and in particular to separate the first electrode 11 from the electrically conductive insert 4. In particular, this external layer of insulating material may therefore contribute to forming the dielectric of the first capacitor C1, that is to say the electrically insulating space, or potentially the space combining electrically insulating layers and electrically conductive elements, which separates the first plate C1_1 from the second plate C1_2 of the first capacitor C1.

In the situation where the object 2 is a pneumatic tire 30, the first electrode 11 may for example be arranged, as may be seen in FIGS. 1, 2 and 3, so as to come into contact with the portion of the coating 3 formed by one and/or the other of the rubber-based beads forming the first and second beads 31A, 31B of the tire 30, and which surround the corresponding bead wires 32A, 32B.

Preferably, the first electrode 11 is integrated within a support 20, such as a jaw, which has a bearing face 20A that is intended to come into contact with the object 2 in order to hold the object 2 while it is being subjected to the action of the material removal tool 5.

Such an arrangement contributes to the simplicity and compactness of the detection system 10, and more generally of the device 1. This arrangement furthermore promotes stable positioning of the first electrode 11 with respect to the object 2, and more particularly with respect to the electrically conductive insert 4, thereby guaranteeing good precision and good reproducibility of the impedance measurements that depend on this positioning of the first electrode 11 with respect to the electrically conductive insert 4.

In the situation where the object 2 is a pneumatic tire 30, the support 20 may comprise a set of jaws, here for example four jaws, which are distributed in azimuth, preferably distributed uniformly in azimuth, about the central axis X30 of the tire 30, which central axis X30 corresponds to the future axis of rotation of the wheel receiving the tire 30. The jaws are then preferably arranged so as each to come into radial centrifugal abutment against at least one, and preferably simultaneously against each of the first and second beads 31A, 31B of the tire 30, as illustrated in FIGS. 1 and 2. The first electrode 11 may advantageously be housed in at least one of the jaws.

It should be noted that the increased number and distribution of the jaws also makes it possible to subdivide and distribute the first electrode 11 into the same number of sub-electrodes, and thus to extend the overall surface area of the first electrode 11 while at the same time distributing this surface area over a large zone of the object 2, here over the periphery of the first and second beads 31A, 31B, thereby improving the reliability and sensitivity of the detection system 10.

The detection system 10 also comprises a second electrode 12 that is associated with the material removal tool 5 such that, when the material removal tool 5 comes into contact with the electrically conductive insert 4, an electrical connection is established between the second electrode 12 and the electrically conductive insert 4 that forms the second terminal D1_2 of the first dipole D1, here more preferably the second plate C1_2 of the first capacitor C1.

Thus, when the material removal tool 5 reaches the electrically conductive insert 4, this has the effect of closing a circuit branch B1, referred to as “first branch” B1, of an electrical circuit 13 of the capacitive detection system 10, hereinafter “detection circuit 13”, which first branch B1 comprises the first dipole D1, here the first capacitor C1, and the second electrode 12. This closing of the first branch B1 will induce a change in impedance, more preferably a change in capacitive impedance, across the terminals of the first branch B1, and more generally in the detection circuit 13 of the detection system 10, which change in impedance will be perceived by the capacitive detection system 10, as will be detailed below.

Preferably, for ease of implementation, the second electrode 12 is formed by a conductive part, more preferably a metal part, of the material removal tool 5. For example, when the material removal tool 5 is formed by a brush, the second electrode 12 may be formed by the metal bristles of the brush, which are themselves connected to a conductor, such as the casing of the tool 5.

The electrical contact between the second electrode 12 and the electrically conductive insert 4 is thus advantageously established as soon as the material removal tool 5 reaches the electrically conductive insert 4.

The detection system 10 according to the present disclosure furthermore comprises a control unit 14 that is arranged so as to measure an impedance of a detection circuit 13 containing the first dipole D1 and to detect a variation in the impedance of the detection circuit 13 caused by the electrical connection of the first dipole D1 to the second electrode 12 brought about by the material removal tool 5 coming into contact with the electrically conductive insert 4.

More particularly, the control unit 14 is arranged so as to detect a variation in the impedance of the detection circuit 13, preferably a variation in the capacitive impedance of the detection circuit 13, which is caused by the electrical connection of the first capacitor C1 to the second electrode 12, which connection is brought about by the material removal tool 5 coming into contact with the electrically conductive insert 4 that forms the second plate C1_2 of the first capacitor C1.

Any variation in the impedance of the detection circuit 13, and more particularly any variation in the capacitive impedance of the detection circuit 13, which is representative of the electrically conductive insert 4 being exposed by the material removal tool 5, is thus perceived immediately by the control unit 14, which may then signal this to the operator and, more preferably, automatically take appropriate measures to prevent any damage to the electrically conductive insert 4 caused by the material removal tool 5.

To this end, the control unit 14 is preferably arranged so as, when it detects the material removal tool 5 coming into contact with the electrically conductive insert 4, to stop the action of the material removal tool 5 on the object 2.

To stop the action of the material removal tool 5 on the object 2, the control unit 14 may for example move the material removal tool 5 away from the object 2, or else stop the cutting movement driving the material removal tool 5 relative to the surface of the object 2, typically by stopping the rotation of the rotary brush when the material removal tool 5 is formed by such a brush.

Advantageously, the capacitive detection system 10 makes it possible to adjust the hollowing depth automatically and on a case-by-case basis, and thus to adapt the action and penetration depth of the material removal tool 5 to the effective thickness of the coating layer 3. The present disclosure thus makes it possible in particular to remove the entire thickness of the coating layer 3, for example the entire thickness of the tread 34, without any risk of damaging the electrically conductive insert 4, and in particular without any risk of severing a cable present in a reinforcing ply 36, 37, 38 or of altering the cable through overheating (bluing) that might be caused by intense friction of the tool 5 against the cable.

Furthermore, the fact that the detection system 10, and more particularly the operation of the detection circuit 13, is based on an impedance measurement that depends on electrical properties determined by the object 2 itself, and more particularly the preferably capacitive character of the detection system 10 when the detection circuit 13 is based on at least one (first) capacitor C1 the structure, and therefore electrical properties, of which are determined by the object 2 itself, makes it possible to excite the detection circuit 13 and to carry out an impedance measurement, by way of an electrical signal, referred to as “excitation signal”, which has a low amplitude and a low intensity and which therefore does not generate any electrical risk either for the device 1 or for the operator.

Preferably, the control unit 14 thus applies, to the detection circuit 13, an excitation signal that represents a potential difference the maximum value of which is equal to or less than 50 V, or even equal to or less than 10 V, or even equal to or less than 5 V.

Advantageously, such a precaution makes it possible to intrinsically have a detection system 10 and more generally a device 1 that are perfectly safe for the operator and compliant with the most stringent safety standards, without it being necessary to fit the detection system 10 or the device 1 with specific safety equipment that becomes mandatory when using higher voltages, typically voltages greater than 50 V. In this case too, the present disclosure therefore makes it possible to keep a detection system 10 and a device that are relatively simple, compact and inexpensive.

Moreover, the detection signal that the control unit 14 applies to the detection circuit 13 is preferably an alternating excitation signal the frequency of which will preferably be equal to or greater than 10 kHz, preferably equal to or greater than 20 kHz, and more preferably equal to or greater than 100 kHz. The frequency is preferably less than or equal to 500 MHz, and more preferably equal to or less than 10 MHz. For example, the frequency may be between 10 kHz and 800 kHz, preferably between 100 kHz and 600 kHz, and more preferably between 200 kHz and 500 kHz.

A relatively high frequency, typically equal to or greater than 10 kHz, and preferably equal to or greater than 100 kHz, advantageously gives the detection system 10 a very short response time during the impedance measurement, and therefore excellent responsiveness that enables the control unit 14 to detect the material removal tool 5 coming into contact with the insert 4 very early, and therefore to stop the action of the material removal tool 5 in time before the latter damages the insert 4 due to prolonged or excessively high-pressure contact.

A relatively high frequency, typically equal to or greater than 10 kHz, and preferably equal to or greater than 100 kHz, also makes it possible to avoid disturbing the impedance measurement with parasitic signals emitted by certain electrical apparatuses, such as motors, present within the device 1 or in the immediate environment of the device.

Furthermore, and in particular in the case where the detection is based mainly or even exclusively on a capacitive impedance component, a relatively high frequency makes it possible to generate a current great enough for the characteristics of the current to be able to be measured easily, and therefore for the impedance measurement to be particularly reliable.

By way of indication, the excitation signal that the control unit 14 applies to the first electrode 11, preferably forming the first plate C1_1 of the first capacitor C1 here, and more particularly that the control unit 14 applies between the first electrode 11 and the second electrode 12 associated with the material removal tool 5, may be an alternating signal, preferably a sinusoidal signal, having an amplitude less than or equal to 50 VAC, preferably less than or equal to 10 VAC, for example less than or equal to 5 VAC.

The excitation signal may be generated by any appropriate generator 17 fitted to the control unit 14, for example an AC voltage generator 17.

In absolute terms, it would be possible to use a “floating” assembly, that is to say use only the first dipole D1, here the first capacitor C1, determined by the object 2 itself, and more generally only the first branch B1 of the detection circuit 13, to measure the impedance, and in particular the capacitive impedance, of the first branch B1 and detect a variation in this impedance that would be characteristic of the material removal tool 5 coming into contact with the insert 4.

However, in order to improve the reliability of the detection system 10, and in particular in order to define a reference impedance value Z2_ref, C2_ref with respect to which the variations in impedance will be evaluated, which reference impedance value may additionally be refreshed just before each material removal operation in order to avoid drift phenomena attributable for example to variations in temperature or humidity in the environment of the device 1, or else in order to avoid interference phenomena related in particular to the presence, within the support 20, of metal masses that are thereby very close to the first dipole D1 and may therefore form parasitic capacitances that cause leakage currents, for example, the inventors have discovered that it was preferable to associate, with the first branch B1 of the detection circuit 13, a second branch B2 having a known impedance, and more particularly to thus place, in the second branch B2, a second dipole D2, more particularly a second capacitor C2, with known characteristics.

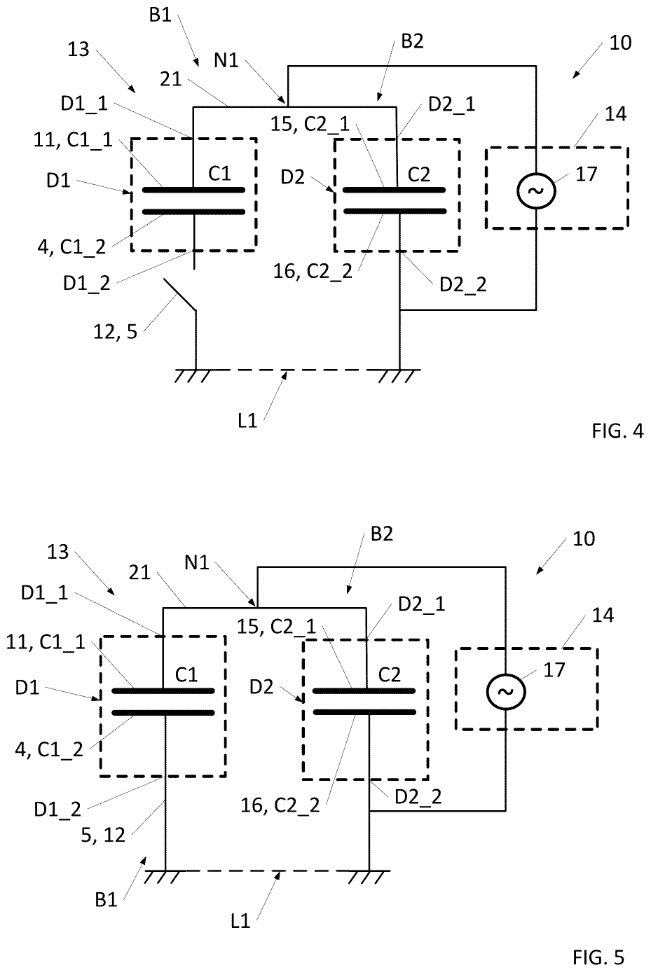

This is why, as may be seen in particular in FIGS. 4 and 5, the detection circuit 13 preferably comprises a second dipole D2 that is distinct from the first dipole D1. This second dipole D2 has a first terminal D2_1 and a second terminal D2_2.

The first terminal D2_1 of the second dipole D2 is electrically connected to the first terminal D1_1 of the first dipole D1 so as to form a node N1 that is common to the first dipole D1 and to the second dipole D2.

The control unit 14 may then advantageously measure the impedance across the terminals D2_1, D2_2 of the second dipole D2 in order to be able, on the one hand, to acquire a reference impedance value Z2_ref, preferably a reference capacitive impedance value C2_ref, referred to as “no-load impedance” Z2_ref, respectively “no-load capacitance” C2_ref, which is equal to an impedance value that the control unit 14 measures across the terminals D2_1, D2_2 of the second dipole D2 while the material removal tool 5 is located at a distance from the electrically conductive insert 4, and, on the other hand, to detect, with respect to this no-load impedance Z2_ref, respectively with respect to this no-load capacitance C2_ref, a variation in impedance, preferably a variation in capacitive impedance, which is representative of an electrical connection of the first dipole D1 to the second electrode 12 when the material removal tool 5 comes into contact with the electrically conductive insert 4.

More particularly, the detection system 10 may preferably comprise a third electrode 15 that corresponds to the first terminal D2_1 of the second dipole D2 and that forms a first plate C2_1 of a capacitor C2 referred to as “second capacitor” C2, distinct from the first dipole D1, and more particularly distinct from the first capacitor C1, and a fourth electrode 16 that corresponds to the second terminal D2_2 of the second dipole D2 and that forms a second plate C2_2 of the second capacitor C2.

The third electrode 15 forming the first plate C2_1 of the second capacitor C2 is electrically connected to the first electrode 11 forming the first terminal D1_1 of the first dipole D1, and more preferably forming the first plate C1_1 of the first capacitor C1, so as to form a node N1 that is common to the first dipole D1 and to the second capacitor C2, more preferably that is common to the first capacitor C1 and to the second capacitor C2.

The control unit 14 is then arranged so as to measure the impedance across the terminals of the second capacitor C2 so as to be able to detect a variation in impedance, here more particularly a variation in capacitive impedance, brought about by the electrical connection of the first dipole D1, here more preferably of the first capacitor C1, to the second electrode 12 when the material removal tool 5 comes into contact with the electrically conductive insert 4.

Preferably, the second terminal D1_2 of the first dipole D1 and the second terminal D2_2 of the second dipole D2, therefore more particularly here the second electrode 12 and the fourth electrode 16, are both electrically connected to a common conductive line L1 such that the second terminal D1_2 of the first dipole D1 and second terminal D2_2 of the second dipole D2, and more particularly the second electrode 12 and fourth electrode 16, are at one and the same potential.

The first branch B1 and the second branch B2, and therefore the first dipole D1 and the second dipole D2, and more particularly the first capacitor C1 and the second capacitor C2, are thus in parallel with one another. The detection of a variation in impedance, and in particular a variation in capacitive impedance, between the two terminals common to these two branches B1, B2, that is to say between the node N1 and the common conductive line L1, is therefore easy and fast, meaning that the detection system 10 exhibits very fine sensitivity and good responsiveness.

Particularly preferably, the common conductive line L1 belongs to the ground of the device 1, as illustrated in FIGS. 4 and 5.

The ground defines the reference potential of the device 1. The ground is preferably connected to earth so as to have a zero reference potential.

Such an arrangement is advantageously particularly practical and simple, since it is possible to connect the terminals D1_2, D2_2 in question, here the electrodes 12, 16 in question, to ground at any two distinct points of the device 1, provided that these points are themselves connected to ground, thereby making it possible in particular to connect the second electrode 12 and the fourth electrode 16 as desired to any suitable point of the frame of the device 1, of a support of the tool 5, of a casing of the device 1 or of a casing of the tool 5, etc., depending on what is easiest and/or most robust to implement.

Such an arrangement is also particularly safe, since the earthing avoids any risk of accidental electric shock for the operator.

When the detection circuit 13 comprises a second branch B2 as described above, then the abovementioned excitation signal may advantageously be applied to the terminals of the second branch B2, and therefore more particularly to the terminals D2_1, D2_2 of the second dipole D2, here more preferably to the terminals of the second capacitor C2.

Thus, preferably, the control unit 14 applies an alternating excitation signal the frequency of which, as indicated above, is equal to or greater than 10 kHz, preferably equal to or greater than 20 kHz, and more preferably equal to or greater than 100 kHz, to the detection circuit 13, here more preferably to the terminals of the second capacitor C2, between the third electrode 15 and the fourth electrode 16. This frequency is preferably less than or equal to 500 MHz and more preferably equal to or less than 10 MHz. For example, the frequency may be between 10 kHz and 800 kHz, preferably between 100 kHz and 600 kHz, and more preferably between 200 kHz and 500 kHz.

As explained above, a sufficiently high frequency makes it possible in particular to quickly determine the impedance, and more particularly the equivalent capacitance, which exists at any time between the common terminals of the two branches B1, B2, that is to say between the node N1 and the common conductive line L1, and therefore to detect almost instantaneously a variation in the impedance, here a variation in capacitive impedance, which signals the closing of the first branch B1, and therefore the first dipole D1, here the first capacitor C1, being placed in parallel with the second dipole D2, here the second capacitor C2, due to the establishment of the connection between the second electrode 12 associated with the tool 5 and the insert 4 forming the second terminal D1_2 of the first dipole D1, here the second plate C1_2 of the first capacitor C1.

As indicated above, the excitation signal applied to the terminals of the second capacitor C2 preferably has a low voltage amplitude, here less than or equal to 50 VAC, preferably less than or equal to 10 VAC, or even less than or equal to 5 VAC.

Indeed, a low voltage is sufficient to detect a variation in the impedance of the detection circuit 13, even a relatively small one, which is characteristic of the closing of the first branch B1 and therefore of the first capacitor C1 being placed in parallel with the second capacitor C2. A low-voltage and more generally low-power excitation signal is therefore sufficient to give the detection system 10 good sensitivity.

In order to determine the impedance, and therefore detect variations in the impedance, the control unit 14 will preferably be provided with measuring apparatuses for measuring the voltage and the strength of the electric current between two chosen terminals, here preferably the terminals between which the control unit 14 applies the excitation signal, here therefore the terminals N1, L1 common to the first and second branches B1, B2.

It should be noted that the impedance that is measured and the variations in which are monitored may, in absolute terms, be a resistive impedance component, a capacitive impedance component, an inductive impedance component, a combination of two impedance components out of: resistive component, capacitive component and inductive component, or a combination of three resistive, capacitive and inductive components.

Preferably and in particular for ease of construction and implementation of the detection system 10 and of the support 20, and to optimize the precision, sensitivity and responsiveness of the detection system, preference will be given to measuring and monitoring a capacitive impedance component.

Therefore, simply for ease of description, reference may preferably be made below to a detection system 10 based on a capacitive impedance measurement, without this constituting a limitation of the present disclosure.

Preferably, the control unit 14 is arranged so as:
to acquire a reference impedance value Z2_ref, referred to as “no-load impedance Z2_ref”, more particularly a reference capacitive impedance C2_ref referred to as “no-load capacitance” C2_ref, which is equal to an impedance value that the control unit 14 measures across the terminals of the second dipole D2, here a capacitive impedance value that the control unit 14 measures across the terminals of the second capacitor C2, while the material removal tool 5 is located at a distance from the electrically conductive insert 4,
and then to associate, with the no-load impedance Z2_ref, here with the no-load capacitance C2_ref, a predetermined warning threshold Z_thresh, C_thresh that is considered to be representative, with respect to the no-load impedance Z2_thresh, here with respect to the no-load capacitance C2_ref, of a variation in the impedance across the terminals D2_1, D2_2 of the second dipole, here a variation in the capacitive impedance across the terminals of the second capacitor C2, caused by the material removal tool 5 coming into contact with the electrically conductive insert 4,
and then to detect the impedance actually measured across the terminals of the second dipole D2, here the capacitive impedance actually measured across the terminals of the second capacitor C2, crossing the warning threshold Z_thresh, C_thresh.

The no-load impedance Z2_ref, here more particularly the no-load capacitance C2_ref, will correspond here to the impedance measured across the terminals of the second branch B2 while the first branch B1 is open. In practice, the no-load capacitance C2_ref is therefore equal to the intrinsic capacitance of the second capacitor C2.

The warning threshold Z_thresh, C_thresh may be defined for example as the sum of the no-load impedance Z2_ref, more particularly the no-load capacitance C2_ref, and a predetermined deviation Delta_Z, respectively Delta_C, which will have been identified for example empirically by way of a test campaign conducted on a sample of multiple objects 2, as being representative of the variation in impedance caused, across the terminals of the second branch B2, and therefore here more particularly across the terminals of the second capacitor C2, by the closing of the first branch B1, that is to say the addition, in parallel with the second dipole D2, here in parallel with the second capacitor C2, of the first dipole D1, here of the first capacitor C1, which takes place when the second electrode 12 associated with the material removal tool 5 comes into contact with the insert 4 forming the second terminal D1_2 of the first dipole D1 and therefore here the second plate C1_2 of the first capacitor C1:

$$Z\_thresh = Z 2 \_ref + Delta\_Z , or , more particularly :$$

$$C\_thresh = C 2 \_ref + Delta\_C$$

Advantageously, by measuring the no-load impedance Z2_ref, here the no-load capacitance C2_ref, of the detection system 10 prior to each new material removal operation, the reference with respect to which the variation in impedance will occur is identified, that is to say the “zero” of the impedance measurement is fixed, thereby making it possible to recalibrate the detection system 10 in each operation and thus improve precision. In particular, this recalibration makes it possible to avoid drifts that induce variations over time in the no-load impedance Z2_ref, and more particularly in the no-load capacitance C2_ref, which drifts may in particular result from variations in temperature or humidity to which the device 1, the support 20 and the detection system 10 are exposed.

In practice, with the object 2 being in place on the support 20, and before the material removal tool 5 approaches the object 2 and engages with the electrically insulating coating 3, the control unit 14 applies the excitation signal to the terminals N1, L1 of the second branch B2, here to the terminals of the second capacitor C2, and measures the current in order to deduce therefrom the no-load impedance Z2_ref, here the no-load capacitance C2_ref. The control unit 14 then associates, with the no-load impedance Z2_ref, here with the no-load capacitance C2_ref, a warning threshold Z_thresh, respectively C_thresh, typically by adding, to the no-load impedance Z2_ref, here to the no-load capacitance C2_ref, a deviation Delta_Z, respectively a predetermined deviation Delta_C, which may be defined for example either based on a fixed value provided by the user or based on a table or a pre-established law possibly stored in a memory of the control unit 14.

The control unit 14 continues to permanently apply the excitation signal to the terminals of the second branch B2 while the material removal operation starts and continues in order to monitor the evolution of the current arriving at the node N1 while the material removal tool 5 is hollowing out the electrically insulating coating 3 and is thus approaching the insert 4 buried under the coating 3.

The control unit 14 thereby measures the impedance between the terminals of the second branch B2, here between the node N1 and the common conductive line L1, at all times and is therefore able to compare the actual value of the impedance with the fixed warning threshold Z_thresh, C_thresh at all times.

As soon as crossing of the warning threshold Z_thresh, C_thresh is detected, which crossing preferably results here from an increase in the apparent capacitance across the terminals of the second branch B2 brought about by the addition, in parallel with the second branch B2, of the first branch B1 containing the first capacitor C1, such that the total capacitance across the common terminals of the two branches B1, B2 corresponds to the sum of the individual capacitances of the first capacitor C1 and of the second capacitor C2, the control unit 14 deduces therefrom that the material removal tool 5 has come into contact with the insert 4 and responds by taking appropriate measures, for example by sending, to a system that manages the positioning of the tool 5 with respect to the object 2 and/or the relative driving of the tool 5 with respect to the object 2 with a desired cutting movement (or vice versa, that manages the positioning of the object 2 with respect to the tool 5 and/or the relative driving of the object 2 with respect to the tool 5), a command for stopping the cutting movement and/or for moving the tool 5 away from the object 2, and therefore from the exposed insert 4.

By way of indication, the value of the no-load capacitance C2_ref may generally be between 1.5 nF (one point five nanofarads) and 3 nF (three nanofarads).

This value will in particular be the result of a compromise between structural constraints related to the dimensioning and the installation of the third and fourth electrodes 15, 16, the need to have a no-load capacitance well suited to the calibre of the impedance measuring apparatus, and the need to have a no-load capacitance that makes it possible, at a low excitation voltage, to observe a current the strength of which is high enough to be insensitive to noise or parasitic leakage currents.

The chosen deviation Delta_C, the value of which is strictly less than the foreseeable capacitance of the first capacitor C1, will for its part preferably be between 30 pF (thirty picofarads) and 150 pF (one hundred and fifty picofarads), more preferably between 50 pF (fifty picofarads) and 100 pF (one hundred picofarads).

This deviation will in particular be chosen to be high enough not to be able to be confused with a parasitic phenomenon, since this would otherwise risk causing false positives, and low enough to allow effective and relatively fast detection.

According to one preferred structural feature, the first electrode 11 and the third electrode 15 are formed by one and the same common conductive part 21, which is preferably made of metal, referred to as “first conductive part”, which simultaneously forms the first plate C1_1 of the first capacitor C1 and the first plate C2_1 of the second capacitor C2.

Such an arrangement has the advantage, on the one hand, of being compact and simple, in particular because it makes it possible to integrate the first and third electrodes 11, 15 into the support 20, and, on the other hand, of providing reliable operation of the detection circuit 13, by virtue in particular of the extent of the first conductive part 21 and the stable holding thereof against the object 2.

The first conductive part 21 may take the form of a plate or a blade made of electrically conductive material, for example steel.

Preferably, the first conductive part 21 will be integrated into the support 20, and its shape will preferably substantially match the shape of the object 2, and more particularly the shape of the surface of the object 2, against which the support 20 is intended to bear.

The first conductive part 21 may thus be formed by a curved blade integrated into a jaw that fits within the curvature formed by the first and/or second bead 31A, 31B about the central axis X30, and therefore that fits within the curvature of the bead wire of the tire 30.

Preferably, the support 20, and more particularly the jaw in question, and in particular the first conductive part 21, extends axially over a distance at least equal to that separating the first bead 31A from the second bead 31B, so as to simultaneously support the two beads 31A, 31B, as may be seen in FIG. 2.

Advantageously, the first conductive part 21 will constitute the node N1 from which the first branch B1 and the second branch B2 of the detection circuit 13 fork off.

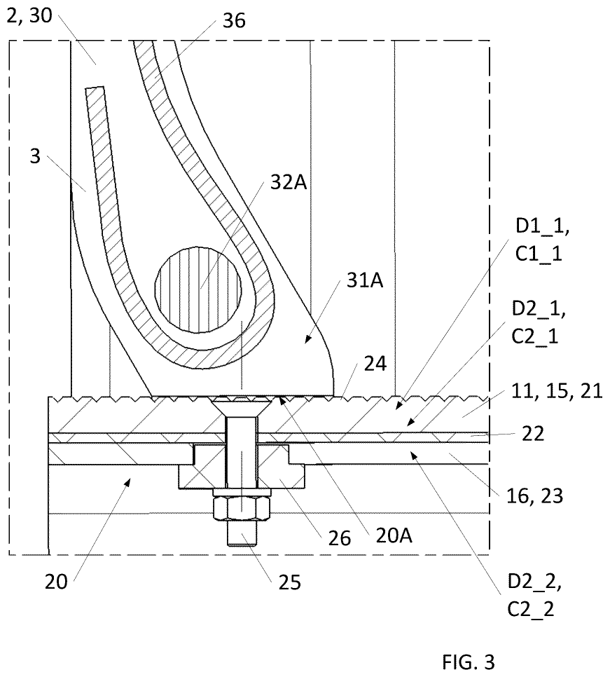

Furthermore, as may be seen in FIG. 3, the bearing face 20A of the support 20, and therefore more particularly the corresponding face of the first conductive part 21, here the radially external face of the first conductive part 21, may be provided with striations 24 so as to exhibit better attachment to the object 2.

According to one possible implementation, it is possible to apply an exposed, electrically conductive bearing face 20A directly against the object 2, provided of course that this bearing face 20A is not connected to ground, in order to avoid grounding the node N1, since otherwise this would have the effect of grounding the two terminals of the first dipole D1 and/or the two terminals of the second dipole D2 simultaneously, and thus preventing an impedance measurement between these terminals.

In particular, it is then possible to use a first conductive part 21, preferably made of metal, the external face of which is exposed and directly forms the bearing face 20A against which the object 2, here the bead 31 of the tire 30, bears.

This will be possible in particular when the structure of the object 2 guarantees the absence of a hard short circuit, and therefore the actual existence of an actually measurable impedance, between the insert 4 and the zone of the object 2 against which the first electrode 11, here the electrically conductive bearing face 20A of the support 20, bears. This is the case for example in the situation of a tire 30 that has at least one rubber-based electrically insulating layer, in particular the rubber beads surrounding the bead wires 32A, 32B, which is interposed between the first electrode 11 and the cables of the reinforcing ply 36, 37, 38 forming the electrically conductive inserts 4.

However, as a variant, provision could nonetheless be made to coat the bearing face 20A, and therefore in particular the external face of the first conductive part 21, with a layer of electrically insulating material, in order to avoid creating direct electrical contact, and therefore a short circuit, between the first conductive part 21, and therefore the first electrode 11, and the electrically conductive insert 4 should the electrically insulating coating 3 be absent or degraded in the zone where the support 20 bears against the object 2.

This is why, according to another possible implementation, the bearing face 20A of the support 20, and therefore here the radially external face of the first conductive part 21, is covered with an electrically insulating protective layer.

This protective layer, which is radially external here, will prevent any short circuit between the first electrode 11 and the electrically conductive insert 4, and may advantageously contribute to forming at least part of the dielectric of the first capacitor C1.

According to one preferred feature, and as may be seen in FIG. 3, the abovementioned support 20, into which the first electrode 11 is integrated, has a layered structure that comprises the common first conductive part 21 forming the first electrode 11 and the third electrode 15, an electrically insulating layer 22 that covers the first conductive part 21 on the side of the first conductive part 21 opposite the bearing face 20A, here therefore the radially internal face of the first conductive part 21, so as to form the dielectric of the second capacitor C2, and a second conductive part 23 that covers the electrically insulating layer 22 to form the fourth electrode 16, and therefore the second plate C2_2 of the second capacitor C2.

In this case too, such an arrangement makes it possible to have a simple, compact, reliable and robust structure, which alone forms the second branch B2 and part of the first branch B1, and which combines mechanical support functions with electrical detection functions.

The second conductive part 23 may be formed by a plate or a blade made of electrically conductive material, for example metal, curved if necessary to match the shape of the object 2 to be supported.

In the case where the support 20 is formed by a jaw intended to support the bead 31A, 31B of an annular tire 30, and therefore to match the curvature of the circular bead wire that reinforces the bead 31, the second conductive part 23 may be formed by a blade, which is preferably curved concavely with respect to the central axis X30, which blade will be located in a radially internal position with respect to the central axis X30, and on which the following will be stacked in terms of thickness, in this order, in increasing distance from the central axis X30: the electrically insulating layer 22, and then the first conductive part 21, which will take the form of a blade, which is preferably curved, radially outwardly offering a bearing face 20A, which is preferably concave with respect to the central axis X30, suitable for receiving the bead 31A, 31B.

The layered structure may be held by way of one or more screws 25.

The screws 25 may advantageously be insulated from the second conductive part 23 by way of insulating washers 26, in order to avoid short-circuiting the second capacitor C2, as may be seen in FIG. 3.

Preferably, the screws 25 will be, on the one hand, in contact with the first conductive part 21 and, on the other hand, insulated from the second conductive part 23 and will pass through the layered structure, so as to be able to be connected to a wire connected to the control unit 14, and more particularly to the generator 17. The first electrode 11 formed by the first conductive part 21 may thus easily be supplied with power, and the strength of the current arriving at the node N1 may easily be measured.

Preferably, the device 1 comprises a motorized displacement system 40, placed under the control of the control unit 14, which makes it possible alternately to bring the material removal tool 5 into contact with the object 2 and then to move the material removal tool 5 away from the object 2.

For this purpose, the motorized displacement system 40 may comprise a robotic arm 41, for example a six-axis anthropomorphic robotic arm the end of which carries the material removal tool 5.

According to one possible implementation, the object will be held by the support 20 in a fixed position with respect to the frame of the device 1, and it is therefore the motorized displacement system 40 that will position and displace the tool 5 relative to the support 20 and the object 2 in order to carry out the one or more material removal operations in one or more identified zones on the object 2.

Of course, without departing from the scope of the present disclosure, the motorized displacement system 40 could, conversely, comprise a fixed tool holder and a mobile support 20 arranged so as to displace the object 2, here the tire 30, with respect to the material removal tool 5, or else a combination of a mobile tool holder, of robotic arm type, enabling the tool 5 to be displaced in space, with respect to the frame of the device 1 and a mobile support 20 enabling the object 2 to be displaced and positioned in space, with respect to this same frame of the device 1.

According to one possible embodiment, the motorized displacement system 40 comprises a force sensor that makes it possible to measure a reaction force exerted by the object 2 against the material removal tool 5.

The force sensor advantageously enables the motorized displacement system 40, in the manner of a touch probe, to carry out an initial setting prior to the material removal operation, by bringing the tool 5 close to the object 2, while the tool 5 is inactive, for example while the brush is not being driven in rotation, until the force sensor detects that the tool 5 has come into contact with the object 2, thereby indicating to the motorized displacement system 40, and therefore to the control unit 14, the position of the surface of the object 2 in space.

The force sensor may also provide safety, which is redundant with the impedance measurement-based detection system 10, in that the force sensor is capable of detecting the mechanical reaction force opposed by the electrically conductive insert 4 when the tool 5 reaches the insert 4, or a variation in the evolution of the resistance force that opposes the penetration of the tool 5 into the object 2, for example the resistance torque that opposes the rotation of the brush, between the situation where the tool 5 gradually sinks into the coating 3 preceding the insert 4, here the rubber layer preceding a metal reinforcing cable, and the situation where the tool reaches the insert 4, here reaches the metal reinforcing cable.

Although the response time of this force sensor-based detection is longer than the particularly short response time of the impedance measurement-based electrical detection system 10, which is typically less than 30 milliseconds, this mechanical detection nevertheless offers additional safety that makes it possible to prevent excessive damage to the insert 4, or causing damage to the material removal tool 5, in the event of failure of the capacitive detection system 10.

Similarly, in order to increase operational safety, when the tool 5 is formed by a rotary brush, provision could be made for a torque sensor that is capable of detecting a variation in material removal torque when the brush encounters the insert 4, after having hollowed out the electrically insulating coating 3.

The present disclosure of course also relates to a detection method for detecting a material removal tool 5 coming into contact with an electrically conductive insert 4 present in an object 2 in a material removal operation during which at least part of an electrically insulating coating 3 that covers the at least one electrically conductive insert 4 is removed from the object 2 by way of the material removal tool 5. This detection method may of course take on any one of the forms described above.

According to the detection method:
a first electrode 11 is placed opposite the object 2, preferably in contact with the object 2, at a distance from the electrically conductive insert 4, so as to form, with the electrically conductive insert 4, a first dipole D1, a first terminal D1_1 of which is formed by the first electrode 11 and a second terminal D1_2 of which is formed by the electrically conductive insert 4,
a second electrode 12 is associated with the material removal tool 5 such that, when the material removal tool 5 comes into contact with the electrically conductive insert 4, an electrical connection is established between the second electrode 12 and the electrically conductive insert 4 forming the second terminal D1_2 of the first dipole D1,
a variation in the impedance, preferably a variation in the capacitive impedance, of a detection circuit 13 containing the first dipole D1 is detected, the variation being caused by the electrical connection of the first dipole D1 to the second electrode 12 when the material removal tool 5 comes into contact with the electrically conductive insert 4.

Preferably, according to this detection method, the first electrode 11 is placed opposite the object 2, preferably in contact with the object 2, at a distance from the electrically conductive insert 4, so as to form, with the electrically conductive insert 4, a capacitor C1, referred to as “first capacitor” C1, a first plate C1_1 of which is formed by the first electrode 11 corresponding to the first terminal D1_1 of the first dipole D1 and a second plate C1_2 of which is formed by the electrically conductive insert 4 corresponding to the second terminal D1_2 of the first dipole D1, and provision is made for a second capacitor C2, distinct from the first capacitor C1 and the first plate C2_1 of which is electrically connected to the first plate C1_1 of the first capacitor C1 so as to form a node N1 that is common to the first capacitor C1 and to the second capacitor C2, and the impedance across the terminals of the second capacitor C2 is measured in order to detect a variation in impedance, here more preferably a variation in capacitive impedance, brought about by the electrical connection of the first capacitor C1 to the second electrode 12 when the material removal tool 5 comes into contact with the electrically conductive insert 4.

Preferably, the second electrode 12, on the one hand, which is connected to the second terminal D1_2 of the first dipole, here preferably to the second plate C1_2 of the first capacitor C1, when the material removal tool 5 comes into contact with the electrically conductive insert 4, and the second plate C2_2 of the second capacitor C2, on the other hand, are electrically connected to a common conductive line L1 so as to be placed at one and the same potential, preferably to a common conductive line L1 forming a ground connected to earth.

Preferably, as indicated above, an AC voltage with a frequency equal to or greater than 10 kHz, preferably equal to or greater than 100 kHz, preferably between 100 kHz and 800 kHz, for example between 200 kHz and 500 kHz, is applied across the terminals of the second capacitor C2, and the strength of the electric current arriving at the node N1 common to the first capacitor C1 and to the second capacitor C2 is measured in order to determine the impedance across the terminals of the second capacitor C2.

Finally, the present disclosure relates more particularly to a method for processing a tire 30, such as a pneumatic tire, which comprises at least one rubber layer forming an electrically insulating coating 3 and at least one reinforcing ply 36, 37, 38 comprising metal reinforcing cables forming electrically conductive inserts 4, the processing method comprising at least one hollowing-out step during which at least part of the rubber covering the reinforcing cables is removed by way of a material removal tool 5, such as a metal brush or a rasp, the processing method being characterized in that it implements a detection method according to the present disclosure to detect the material removal tool 5 coming into contact with one or more reinforcing cables.

In other words, the present disclosure may advantageously be applied to the repair of carcasses of tires 30 with a view to retreading the tires, and more generally to any form of recycling of all or some tires 30 involving a rubber removal operation.

That being the, it should be noted that, more generally, the present disclosure may advantageously be applied to the repair or recycling of any object 2 having a structure comprising a conductive reinforcement, preferably formed by one or more metal reinforcing cables, embedded in an insulating matrix, typically a rubber-based matrix, all or part of which it is desired to remove; such an object 2 may be for example a track intended to propel a vehicle, a conveyor, a belt, a seal, etc.

Preferably, the first electrode 11 will be fixed close to, and more preferably against, a bead 31A, 31B of the tire 30, while the material removal tool 5, whether it is operated manually by an operator or, preferably, automatically by an automatic motorized displacement system 40, will be used to eat away, through cutting or abrasion, the rubber layer constituting the tread 34 covering the crown 33 of the tire 30 or the rubber layer covering a sidewall 35A, 35B of the tire 30.

According to one possible application of the detection method according to the present disclosure, may be applicable to any object 2 having an appropriate structure, and in particular applicable in the context of an abovementioned method for processing a tire 30, the object 2, and more particularly here the tire 30, comprises a plurality of different reinforcing plies 36, 37, 38 having reinforcing cable structures specific to each of them, the reinforcing cables forming electrically conductive inserts 4, and the detection method is able to distinguish, based on the variation in impedance observed when the material removal tool 5 comes into contact with one or more reinforcing cables of one of the reinforcing plies 36, 37, 38, the reinforcing cable structure, and therefore the reinforcing ply 36, 37, 38, out of the plurality of reinforcing plies that are present, with which the material removal tool 5 has come into contact.

For this purpose, it is possible to identify, for example through a sampling campaign carried out on one or more objects 2, here one or more tires 30, a plurality of warning thresholds Z_thresh, C_thresh of different values, forming multiple levels, and which each correspond to a particular structure of a reinforcing ply 36, 37, 38. These values may for example be stored in a non-volatile memory of the control unit 14, in the form of a table, library, map, chart, etc.

The value of the impedance, and more particularly of the capacitive impedance, which will be measured by the control unit 14 when the tool 5 comes into contact with reinforcing cables forming the insert 4 may then be compared with these warning thresholds Z_thresh, C_thresh in order to determine the crossed threshold to which the measured impedance value is closest, and therefore the reinforcing ply structure to which the cables thus touched by the tool 5 belong.

Advantageously, it is therefore possible to use the detection method according to the present disclosure to identify the type of reinforcing ply with which the tool 5 has come into contact.

This may in particular make it possible to adapt the material removal process, for example by repositioning the tool 5 with respect to the object 2, here with respect to the tire 30, or else by adapting the speed of the cutting movement as a function of the zone of the object 2, here of the tire 30, which is subject to the material removal.

Of course, the present disclosure is in no way limited just to the variant embodiments described above, and a person skilled in the art could in particular isolate or freely combine any of the abovementioned features, or replace them with equivalent features.

What is claimed is:

1. A material removal device intended to work on a pneumatic tire, comprising an electrically insulating coating that covers at least one electrically conductive insert, said device comprising at least one material removal tool that is arranged so as to be able to remove some of the electrically insulating coating from the object, said device further comprising a detection system for detecting, through an impedance measurement, the material removal tool coming into contact with the electrically conductive insert, said detection system comprising:
a first electrode that is arranged so as to be placed opposite the object, at a distance from the electrically conductive insert, so as to form, with said electrically conductive insert, a first dipole, a first terminal of which is formed by the first electrode and a second terminal of which is formed by the electrically conductive insert,
a second electrode that is associated with the material removal tool such that, when the material removal tool comes into contact with the electrically conductive insert, an electrical connection is established between said second electrode and said electrically conductive insert forming the second terminal of the first dipole,
a control unit that is arranged so as to measure an impedance of a detection circuit containing the first dipole and to detect a variation in the impedance of said detection circuit caused by the electrical connection of the first dipole to the second electrode brought about by the material removal tool coming into contact with the electrically conductive insert.

2. The material removal device according to claim 1, wherein the detection system is a capacitive detection system within which:
the first electrode is arranged so as to be placed opposite the object, at a distance from the electrically conductive insert, so as to form, with said electrically conductive insert, a first capacitor, a first plate of which is formed by the first electrode, corresponding to the first terminal of the first dipole, and a second plate of which is formed by the electrically conductive insert, corresponding to the second terminal of the first dipole,
and the control unit is arranged so as to detect a variation in the impedance of the detection circuit caused by the electrical connection of the first capacitor to the second electrode brought about by the material removal tool coming into contact with the electrically conductive insert that forms the second plate of the first capacitor.

3. The material removal device according to claim 1, wherein the detection circuit comprises a second dipole that is distinct from the first dipole, which second dipole has a first terminal that is electrically connected to the first terminal of the first dipole so as to form a node that is common to the first dipole and to the second dipole, wherein the control unit measures the impedance across the terminals of the second dipole in order to be able, on the one hand, to acquire a reference no load impedance value, which is equal to an impedance value that said control unit measures across the terminals of the second dipole while the material removal tool is located at a distance from the electrically conductive insert, and, on the other hand, to detect, with respect to this no-load impedance, a variation in impedance, preferably a variation in capacitive impedance, which is representative of an electrical connection of the first dipole to the second electrode when the material removal tool comes into contact with the electrically conductive insert.

4. The material removal device according to claim 3, wherein the detection system comprises a third electrode that corresponds to the first terminal of the second dipole and that forms a first plate of a second capacitor, distinct from the first dipole, and a fourth electrode that corresponds to the second terminal of the second dipole and that forms a second plate of said second capacitor.

5. The material removal device according to claim 2, wherein the first electrode and the third electrode are formed by one and the same first common conductive part, which simultaneously forms the first plate of the first capacitor and the first plate of the second capacitor.

6. The material removal device according to claim 3, wherein the second terminal of the first dipole and the second terminal of the second dipole are both electrically connected to a common conductive line, such that said second terminal of the first dipole and second terminal of the second dipole are at one and the same potential.

7. The material removal device according to claim 1, wherein the control unit applies an alternating excitation signal the frequency of which is greater than or equal to 10 kHz to the detection circuit.

8. The material removal device according to claim 1, wherein the first electrode is integrated within a support which has a bearing face that is intended to come into contact with the object in order to hold said object while it is being subjected to the action of the material removal tool.

9. The material removal device according to claim 8, wherein the bearing face of the support is covered with an electrically insulating protective layer.

10. The material removal device according to claim 5, wherein the first electrode is integrated within a support which has a bearing face that is intended to come into contact with the object in order to hold said object while it is being subjected to the action of the material removal tool, and wherein the support has a layered structure that comprises the common first conductive part forming the first electrode and the third electrode, an electrically insulating layer that covers said first conductive part on the side of said first conductive part opposite the bearing face, so as to form the dielectric of the second capacitor, and a second conductive part that covers said electrically insulating layer to form the fourth electrode, and therefore the second plate of the second capacitor.

11. A method for detecting a material removal tool coming into contact with an electrically conductive insert present in an object in a material removal operation during which at least part of an electrically insulating coating that covers said at least one electrically conductive insert is removed from said object by way of said material removal tool, said detection method comprising the steps of:
placing a first electrode opposite the object at a distance from the electrically conductive insert, so as to form, with said electrically conductive insert, a first dipole, a first terminal of which is formed by the first electrode and a second terminal of which is formed by the electrically conductive insert,
associating a second electrode with the material removal tool such that, when the material removal tool comes into contact with the electrically conductive insert, an electrical connection is established between said second electrode and said electrically conductive insert forming the second terminal of the first dipole,
detecting a variation in the impedance of a detection circuit containing the first dipole, said variation being caused by the electrical connection of the first dipole to the second electrode when the material removal tool comes into contact with the electrically conductive insert.

12. The method according to claim 11, wherein the first electrode is placed opposite the object at a distance from the electrically conductive insert, so as to form, with said electrically conductive insert, a first capacitor, a first plate of which is formed by the first electrode corresponding to the first terminal of the first dipole and a second plate of which is formed by the electrically conductive insert corresponding to the second terminal of the first dipole, and provision is made for a second capacitor, distinct from the first capacitor and the first plate of which is electrically connected to the first plate of the first capacitor so as to form a node that is common to the first capacitor and to the second capacitor, and the impedance across the terminals of the second capacitor is measured in order to detect a variation in impedance brought about by the electrical connection of the first capacitor to the second electrode when the material removal tool comes into contact with the electrically conductive insert.

13. The method according to claim 11, wherein the object comprises a plurality of different reinforcing plies having reinforcing cable structures specific to each of them, said reinforcing cables forming electrically conductive inserts, and wherein said detection method is able to distinguish, based on the variation in impedance observed when the material removal tool comes into contact with one or more reinforcing cables of one of said reinforcing plies, the reinforcing cable structure, and therefore the reinforcing ply, out of the plurality of reinforcing plies that are present, with which said material removal tool has come into contact.

14. A method for processing a tire which comprises at least one rubber layer forming an electrically insulating coating and at least one reinforcing ply comprising metal reinforcing cables forming electrically conductive inserts, said processing method comprising at least one hollowing-out step during which at least part of the rubber covering the reinforcing cables is removed by way of a material removal tool, such as a metal brush or a rasp, said processing method implementing a detection method according to claim 11 to detect the material removal tool coming into contact with one or more reinforcing cables.

15. The material removal device according to claim 5, wherein the first common conductive part is made of metal.

16. The material removal device according to claim 6, wherein the common conductive line belongs to a ground of the device.

17. The material removal device according to claim 7, wherein the frequency of the alternating excitation signal is greater than or equal to 100 kHz.

18. The material removal device according to claim 8, wherein the support is a jaw.

19. The method according to claim 11, wherein the first electrode is placed in contact with the object.

20. The method according to claim 12, wherein the variance in impedance is a variance in capacitive impedance.
